(19) United States
(12) Patent Application Publication
(10) Pub. No.: US 2005/0089025 A1
(43) Pub. Date: Apr. 28, 2005

(54) System and method for sharing an IP address

(76) Inventors: Jean-Denis Boyer, St-Francois-Xavier-de-Brompton (CA); Eric Beaudoin, Sherbrooke (CA)

Correspondence Address: AKERMAN SENTERFITT, P.O. BOX 3188, WEST PALM BEACH, FL, 33402-3188, US

(21) Appl. No.: 10/971,239

(22) Filed: Oct. 22, 2004

Related U.S. Application Data
(60) Provisional application No. 60/513,556, filed on Oct. 24, 2003.

(51) Int. Cl. H04L 12/66; H04L 12/28; H04L 12/56

(52) U.S. Cl. 370/352; 370/401

(57) ABSTRACT

A system and a method allowing local network devices to be connected to a large network using only one IPv4 address, comprising a routing device having an interface to the large network and an interface to the local network. The method comprises providing a routing device hosting an application and having an interface to the large network and an interface to the local network, providing a local network device, connecting the local network device to the LAN interface of the routing device, whereby the routing device shares a public IP address between the application it is hosting and the local network device.

### FIELD OF THE INVENTION

The present invention relates to sharing of an IP address. More specifically, the present invention is concerned with a routing system and method for sharing of an IP address.

### BACKGROUND OF THE INVENTION

Internet users wanting to use network applications hosted by dedicated devices for example generally need obtaining from their Internet Service Provider (ISP) a different IP (Internet protocol) address, such as an IPv4 (Internet Protocol Version 4) address, which uniquely identifies each devices on the Internet, for each device used. Due to a finite number of available IPv4 addresses in the Internet, this is not always possible.

A well known solution to such a type of problems includes using a router that acts as a Network Address Translator (NAT) between a local network, such as a Local Area Network (LAN), and a larger network, such as a Wide Area Network (WAN), as described in Srisuresh, P., <<IP Network Address Translator (NAT) Terminology and Considerations>>, RFC 2663, August 1999, for example. The NAT uses a public IPv4 address to allow a set of devices located on nodes within the LAN to communicate with nodes of the WAN. On the LAN side, private IPv4 addresses are allocated to each device, usually by Dynamic Host Configuration Protocol (DHCP). When a packet of data is sent to the WAN, the NAT translates the private source address into a public address and saves a corresponding data flow as a new connection. When a packet of data is received from the WAN, the NAT identifies it to a corresponding data flow, and translates the public address destination into the private address of a device it is destined for in the LAN. The NAT modifies the IPv4 addressing, and takes special care of protocols such as UDP (User Data Protocol) and TCP (Transmission Control Protocol) to avoid port conflicts; it may further have to translate port numbers.

Interestingly, NAT based systems and methods are efficient in cases when there are a number of nodes in the local LAN. Moreover, solutions based on using a NAT allow an increased security by hiding nodes on the LAN, wherein the nodes behind the NAT using a private IPv4 address are unreachable from a node on the WAN, and packets of data pass through the NAT and are forwarded to the LAN only if a communication, initiated from the LAN, exists.

However NAT based systems and methods may be limited by the limited number of private IP addresses available as mentioned hereinabove, by an available range of port numbers and by the proper performance of the router acting as a NAT.

Besides, there are known drawbacks of NAT based systems and methods. First, the nodes on the LAN ignore the real public IPv4 address. This is a problem when registering to a public server (the Session Initiation Protocol (SIP) is an example), whereby the IPv4 address is copied into the protocol data and thus the NAT is unable to translate it.

Second, the nodes on the LAN cannot easily offer public services, in particular in the cases of server applications that listen to specific ports, since the NAT needs to know these specific server ports to allow connections to be initiated from the WAN.

Finally, NAT's may further require specific translation agents such as Application Level Gateways (ALG) for certain protocols, in the case of special translation performed by the NAT for specific application level protocols. This allows devices connected to the LAN to ignore the presence of the NAT. But as new protocols are created, new ALGs may have to be added without which applications do not operate without the NAT being first updated.

Consequently, when only a reduced number of devices in the local network need to be connected to the large network using only one IPv4 address, the NAT may not be the best solution, due to its complexity and aforementioned disadvantages.

Therefore, there is a need in the art for a routing system and method for sharing a public Internet Protocol address with a single node on a local network.

### SUMMARY OF THE INVENTION

There is provided a routing method for connecting at least one device of a local network to a large network, comprising the steps of providing at least one routing device hosting an application and comprising a first interface to the large network and a second interface to the local network; and connecting the at least one network device to the second interface of the at least one routing device; whereby the at least one routing device shares an Internet Protocol address between the application it is hosting and the at least one network device.

There is further provided a routing system for at least one local network device that requires connections to a large network through using an Internet protocol address, comprising at least one routing device hosting an application and having a first interface to the large network and a second interface to the local network, the at least one routing device sharing an Internet protocol address between the application it is hosting and the at least one local network device.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1 is a general schematic view of a system according to the present invention;

FIG. 2 illustrates a first application of a system according to the present invention;

FIG. 3 illustrates a second application of a system according to the present invention; and

FIG. 4 illustrates a third application of a system according to the present invention.

### DESCRIPTION OF EMBODIMENTS OF THE INVENTION

The present invention provides a routing system and method allowing sharing a public IP address, such as a public IPv4 (Internet Protocol Version 4) address for example, between an application hosted on the routing device and a node of a local network.

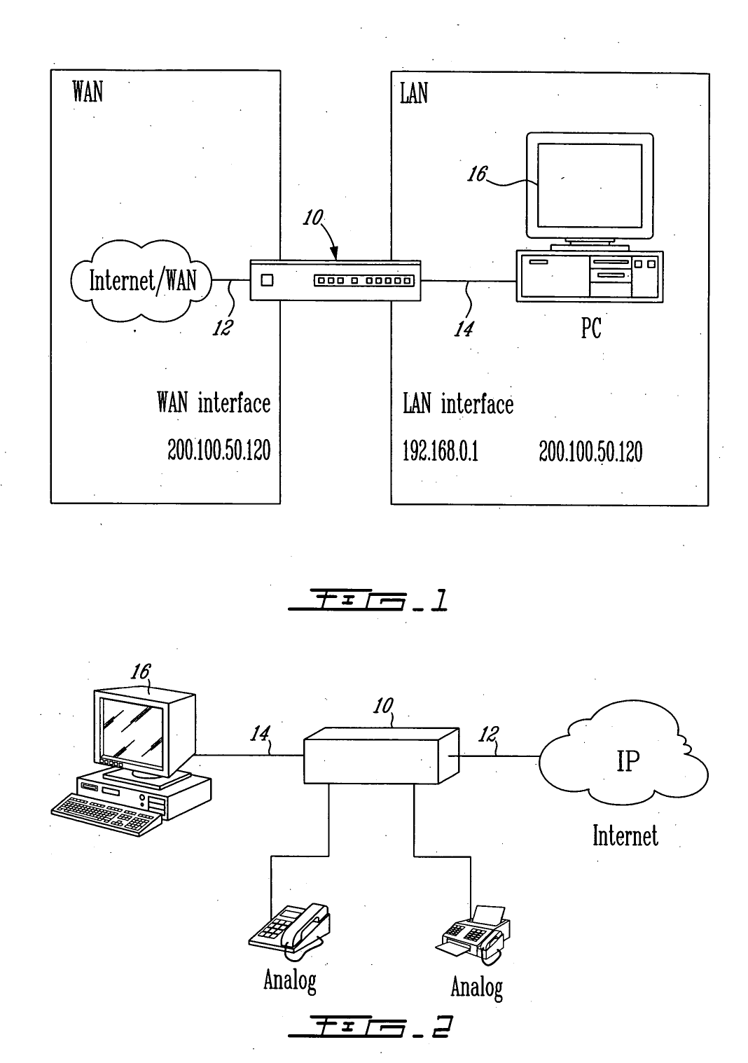

As illustrated in FIG. 1 of the appended drawings, the routing device 10 generally comprises an Internet Protocol interface 12 to connect to a large network such as a WAN, and an Internet Protocol interface 14 to connect to a device 16 of a local network such as a LAN.

The IP interface 12 to the large network is assigned a public IP address, such as an IPv4 address, by an ISP, either by a DHCP negotiation (see for example Droms, R., <<Dynamic Host Configuration Protocol>>, RFC 2131, March 1997), by establishing a point-to-point link (PPP), or by any other mechanism depending on a type of link between the routing device 10 and the large network 12, as is well known in the art.

The IP interface to the local network 14 is assigned a private IP address, such as a private IPv4 address for example, as known in the art (see for example Rekhter, Y., <<Address Allocation for Local Internets>>, RFC 1918, February 1996). This private IP address of the IP interface to the local network 14 is statically configured and allows the device 16 on the local network 14 to communicate with the routing device 10, which would otherwise be impossible since both share a same public IPv4 address, as will be described further hereinbelow.

The device 16 on the local network 14 is assigned the same public IPv4 address as the routing device 10, by using DHCP, and is related to a subnet mask the same as the one assigned by the ISP. Alternatively, if this is not available, such as in the case of a PPP connection for instance, predefined subnet classes are used. The device 16 may be a router for example.

The routing device 10 performs transparent routing as described in the art (see for example Smoot, C-M., <<Using ARP to implement Transparent Subnet Gateways>>, RFC 1027, October 1987), by forwarding to the large network any packet of data sent to any IP address that is included in the large subnet. Thus, a default router assigned to the device 16 on the local network 14 may be any IP address included in the subnet, excluding the one IP address bound thereto of course.

Each packet of data received from the large network, destined for the IP public address, is forwarded directly to the network device 16 on the local network 14, except if it belongs to an existing connection used by the hosted application, or to a server port currently opened. Reversely, each IP packet received from the local network 14 is forwarded to the large network side, except for packets sent explicitly to a private address of the routing device 10.

The routing device 10 may initiate a communication with the device 16 on the local network 14, by using its private IP address as a source address.

People in the art will appreciate that since the device 16 on the local network 14 is bound to the public IP address of the routing device 10, the device 16 knows the real public address that is to be used by other nodes of the large network to reach it, without recurring to an ALG for example.

The present invention therefore simplifies offer of public services, since the device 16 on the local network may easily open server ports, without the need to inform the routing device 10, providing the device 16 does not use the same server ports as the application hosted on the routing device 10, as already mentioned.

As a result, the routing device of the present invention is generally less complex that existing systems, since there is no need to register connections that the device does not own, allowing faster routing decisions with less memory resources.

It is noted that in cases involving more than one device 16, device 16 connected on interface 14 can be a routing device that in turns connects to other devices 16 with additional interfaces.

To compensate for an absence of security hiding behind local IPv4 addressing, a firewall may be used, which may either reside on the device 16 on the LAN 12 or be integrated to the routing device 10 logic.

FIG. 2 illustrates an exemplary application of the device of the present invention for offering VoIP (voice over Internet protocol) or telephony services over the Internet in a residential installation, wherein a routing device 10 with analog phone ports and an embedded telephony application is connected directly to the WAN 12 for allowing a personal computer 16 to be transparently connected to the Internet.

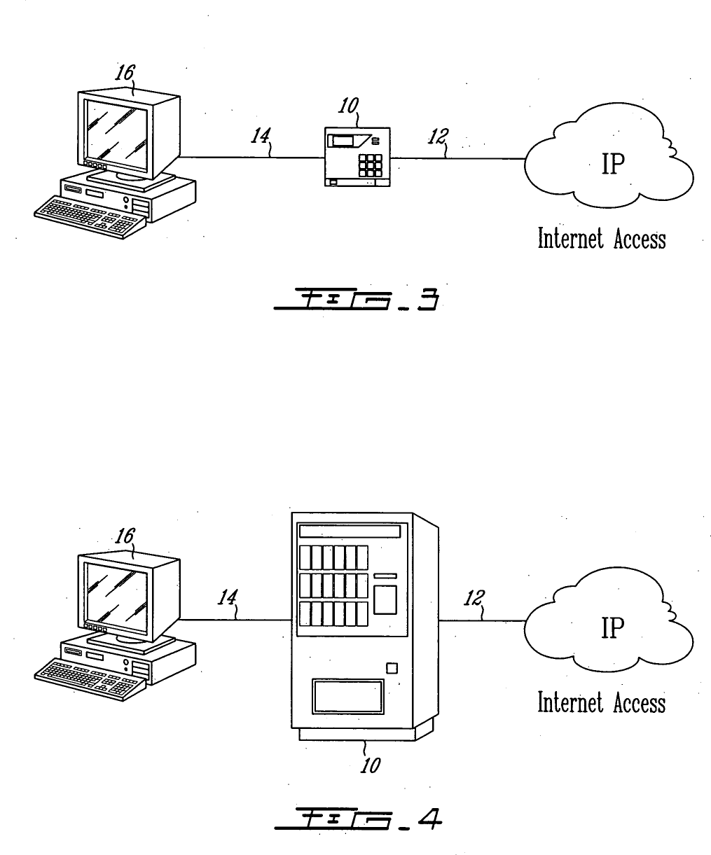

A number of further applications may be contemplated using the routing device of the present invention for local network devices that require connections to the public Internet through the use of an IPv4 address, such as for example alarm systems (see FIG. 3), vending machines (see FIG. 4), etc.

It is to be noted that a number of routing devices 10 may be serially connected one to each other, thereby sharing a same IP address in a daisy chain fashion. For example, a number of IP enabled vending machines in a remote location may be connected serially to a single DSL (digital subscriber line) modem for stock management and security control.

A further embodiment of the present invention may allow sharing one IP address among several devices connected in parallel, by providing separate physical interfaces (one for each device), wherein each interface defines a LAN of its own, and each connection is registered by the routing device. A physically detached local subnet may then be created to allow the devices on the multiple LANs to communicate with each other.

People in the art will appreciate that the present invention also relates to a routing method for sharing a public IP address such as a public IPv4 address, which comprises providing a routing device hosting an application and provided with an interface to a large network such as a WAN and an interface to a local network such as a LAN, providing a network device in the local network, connecting the network device to the LAN interface of the routing device, whereby the routing device shares a public IP, such as a public IPv4 address between the application it is hosting and the network device.

Although the present invention has been described hereinabove by way of embodiments thereof, it may be modified, without departing from the nature and teachings of the subject invention as defined in the appended claims.

1. A routing method for connecting at least one device of a local network to a large network, comprising the steps of:
providing at least one routing device hosting an application and comprising a first interface to the large network and a second interface to the local network; and
connecting the at least one local network device to the second interface of the at least one routing device;
whereby the at least one routing device shares an Internet Protocol address between the application it is hosting and the at least one local network device.

2. The routing method according to claim 1, wherein said step of providing at least one routing device comprises providing at least one routing device comprising a first interface to a wide area network (WAN) and a second interface to a local area network (LAN).

3. The routing method according to claim 1, wherein said step of providing at least one routing device comprises assigning the first interface a public Internet Protocol address and assigning the second interface a private Internet Protocol address, the at least one routing device and the at least one local network device communicating through the private address.

4. The routing method according to claim 1, wherein the at least one local network device is a router.

5. A routing system for at least one local network device that requires connections to a large network, comprising at least one routing device hosting an application and having a first interface to the large network and a second interface to the local network, said at least one routing device sharing an Internet protocol address between the application and the at least one local network device.

6. The routing system according to claim 5, wherein the large network is a wide area network (WAN) and the local network is a local area network (LAN).

7. The routing system according to claim 5, wherein the first interface is assigned a public Internet Protocol address and the second interface is assigned a private Internet Protocol address, said at least one routing device and the at least one network device communicating through said private address.

8. The routing system according to claim 7, wherein each packet of data received from the large network and destined for the public Internet Protocol address is forwarded directly to the at least one local network device, except if it belongs to one of an existing connection used by a hosted application and a server port currently opened; and wherein each packet of data received from the local network is forwarded to the large network, except for packets of data sent explicitly to a private address assigned to the at least one routing device.

9. The routing system according to claim 5, wherein said at least one routing device initiates a communication with the at least one local network device by using a private Internet Protocol address thereof as a source address.

10. The routing system according to claim 5, further comprising a firewall residing on one of: the at least one local network device and said at least one routing device.

11. The routing system according to claim 5, wherein the application hosted on said at least one routing device is an embedded telephony application connected directly to the large network and the at least one local network device is a personal computer transparently connected to the Internet.

12. The routing system according to claim 5, offering one of VoIP and telephony services over Internet.

13. The routing system according to claim 5, comprising a plurality of said routing devices, said routing devices being serially connected.

14. The routing system according to claim 13, wherein said routing devices are IP enabled vending machines.

15. The routing system according to claim 5, comprising a plurality of said routing devices, said routing devices being connected in parallel.

16. The routing system according to claim 5, wherein the at least one local network device is a router.
